(19) United States
(12) Patent Application Publication
(10) Pub. No.: US 2007/0294726 A1
(43) Pub. Date: Dec. 20, 2007

(54) Ipg With Dvd Ordering Facility

(76) Inventor: Jonathan Peter Vincent Drazin, London (GB)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/576,300

(22) PCT Filed: Sep. 29, 2005
(86) PCT No.: PCT/GB05/03768

§ 371 Date: Jul. 16, 2007

(30) Foreign Application Priority Data
Sep. 29, 2004 (GB) 0421703.0

(51) Int. Cl. H04N 7/173; H04N 5/445

(52) U.S. Cl. 725/39; 725/87

(57) ABSTRACT

An interactive television system for displaying on a screen or monitor at least one user selectable identifier (164) associated with an audio/visual media that is available for delivery via a non-electronic channel. Selection of one of the identified audio/visual media causes an order instruction (181) for the user to be displayed, typically including a telephone number (207) that has to be used to place the order and a code (206) for identifying the user selection.

The present invention relates to an interactive television system that supports an improved interactive programme guide (IPG) that provides the facility for users to order and maintain a queue of DVD (Digital Versatile Disc) titles for playback in their homes.

### BACKGROUND OF THE INVENTION

Renting or buying a particular DVD or VHS movie or games title from a shop, and playing it at a time of day according to individual preference, has been a popular aspect of home entertainment for some years. Pay television operators, such as Video Networks Limited's HomeChoice service in the United Kingdom, have sought to give an equivalent convenience through so called “video on demand” (VOD) services that allow consumers to select a movie for immediate playback from a television screen menu. However, play back of VOD services is normally limited to a single point in a home, typically the operator's set-top-box (STB). Hence, the growth of these services is limited by technical and economic network access issues.

With the advent of personal computers (PCs) and the ability to order titles across the internet, mail order DVD clubs have also become increasingly popular. These allow consumers to order DVD titles from a list displayed on their PCs and to receive and return them via the postal network. A consumer subscribing to a club may be allowed to hold up to a certain number of titles, typically between 3 and 20, at home and return them when viewed in order to receive new ones. The club approach has the benefit of saving from consumers the inconvenience of having to fetch and return titles, and allows them to maintain a small library that may played anywhere in the home. Additionally, a club approach brings users the benefit of access to both a greater number of popular titles compared to pay television networks, due to the DVD medium's earlier release dates, and access to a greater number of special interest titles due to limitations of content rights experienced by VOD operators. However, such clubs require consumers to log onto and use a PC to order a title, which is not always convenient and limits the customer base only to those with internet access.

### SUMMARY OF THE INVENTION

According to the present invention, there is provided an interactive programme guide (IPG) for a television system that is operable to display television programme viewing opportunities corresponding to DVD title information received from a service operator and allow a user to select or prioritise these for delivery to the user's address. The IPG allows a user to search for DVD titles using a user interface that is similar to that which the user may employ to find a television programme according to a broadcast schedule, or to locate a programme for viewing from a remote server (e.g. “video on demand”) or from a bard disk local to the television such as within a personal video recorder.

The IPG executes as an application within a home television entertainment platform such as, for example a television, a set-top-box (STB) television receiver, a DVD recorder or a hard disk (HD) based recorder. A user presses keys on a remote handset to send commands to the television platform to control it in a manner where said platform's operation is responsive to the pressing of said keys. In particular, the IPG displays interactive text and images that change in response to keys pressed on the remote handset and to received operator data.

The television platform receives and decodes a data stream from the service operator that is embedded within a television signal. The decoded data stream contains a title catalogue, a title status log and a per subscriber update. The title catalogue is broadcast periodically for downloading by the television platform, preferably while the television platform determines that it is not in use by a user or is placed in standby. The title catalogue contains descriptive notes for each title that may be requested, including title, a numeric identifier, identifiers for one or more genre classification identifiers that describe the title's content, a text description, graphics and video clips. The graphics and video clips may be displayed either inset within the text description or played back to the user as one or more video trailers in full screen or partial screen. The title status log is broadcast with a frequency that is comparable to or greater than the title catalogue, and downloaded by the television platform preferably when the platform is not in use or is placed into a standby mode. The per subscriber update is broadcast to television platforms in real time in response to a user's request for a title.

A user may interact with the IPG so as to subscribe to the club by pressing a key appropriately labelled on the display or handset. The IPG permits the user to view DVD titles and related descriptions by pressing one or more keys appropriately labelled on the display or handset to cause a catalogue of titles to be displayed in an area (“Movie Guide”) on the television screen. The IPG displays information about the titles and may effect a transaction between user and operator whereby one or more titles are requested to be despatched to the user's home on a loan or purchase basis. The IPG further displays status information concerning the availability for despatch of titles and details of which titles have been ordered, despatched or are in possession of the user.

### BRIEF DESCRIPTION OF THE DRAWINGS

Various aspects of the invention will now be described by way of example only and with reference to the accompanying drawings, of which:

FIG. 1 is a block diagram of the overall system comprising a service operator, a broadcaster, a communications network and a television receiving platform;

FIG. 2 is a block diagram of a television system that is configured to receive data from the operator via a broadcast television network;

FIG. 3 is a block diagram of the functions within a digital television receiver;

FIG. 4 is a top view of the remote control handset used in the system of FIG. 2;

FIG. 5 shows how memory is allocated by function in the television platform of FIG. 2;

FIG. 6 is a diagram that shows communications of information between the user, the television and operator that form the title request process in chronological order down the page;

FIG. 7 shows various components of the operator data broadcasts of FIG. 1 and FIG. 2;

FIG. 8 is a data diagram showing the interrelationship between attributes in a catalogue, TitleCatalogue, downloaded to the television platform in advance of a user's interaction with a television platform and a table, TitleAvailability, that is accessed in real time during a user's interaction with the television platform;

FIG. 9 is a flow diagram of the process for loading status messages address addresses to the television platform from a scheduled broadcast;

FIG. 10 shows the screen of the television platform when it is displaying full screen television programme;

FIG. 11 shows the screen of the television platform when it is displaying a service guide whereby the DVD title IPG function (“DVD Movie Guide”) may be selected by a user;

FIG. 12 shows the screen of the television platform when the user is browsing a broadcast television programme schedule within the IPG;

FIG. 13 is a flow diagram of the process for a user request of a title from the operator;

FIG. 14 shows the screen of the television platform when the IPG is displaying a DVD title catalogue;

FIG. 15 shows the screen of the television platform when the IPG is requesting the user to key in a personal identification number;

FIG. 16 shows the screen for the television platform of FIG. 2 where the IPG is requesting a user to dial or send a SMS message to the operator in order to effect a title request;

FIG. 17 shows the screen of the television platform when the IPG is displaying a DVD title catalogue in a first area of the screen, a DVD allocation cell is in focus in a second area for the purpose of simultaneously displaying additional notes concerning it in a third area;

FIG. 18 shows the screen of the television platform when the IPG is displaying a DVD title catalogue containing a cell corresponding to a title that has been requested where additional notes concerning said title are displayed in a second area;

FIG. 19 shows the screen of the television platform when the IPG is displaying a DVD title catalogue in a first portion of the screen and playing a preview of a user selected title in a second portion of the screen;

FIG. 20 shows the screen of the television platform when the IPG is displaying a box where a user may compose a DVD title search keyword;

FIG. 21 shows the screen of the television platform when the IPG is displaying a cell associated with a title that corresponds to a result of a search in focus;

FIG. 22 shows the screen of the television platform when the IPG is displaying a cell associated with a title that corresponds to a result of a search as marked to show that it is requested;

FIG. 23 shows the screen of the television platform when the IPG is displaying a request for a user to input a personal identification number;

FIG. 24 shows the screen of the television platform when the IPG is displaying a request for a user to dial the operator in order to effect a title request;

FIG. 25 shows the screen of the television platform when the IPG is displaying a DVD genre search function with a user selectable genre parameter displayed in focus, and

FIG. 26 shows the screen of the television platform when the IPG is displaying a DVD genre search function with a result displayed in focus.

### SPECIFIC DESCRIPTION OF THE DRAWINGS

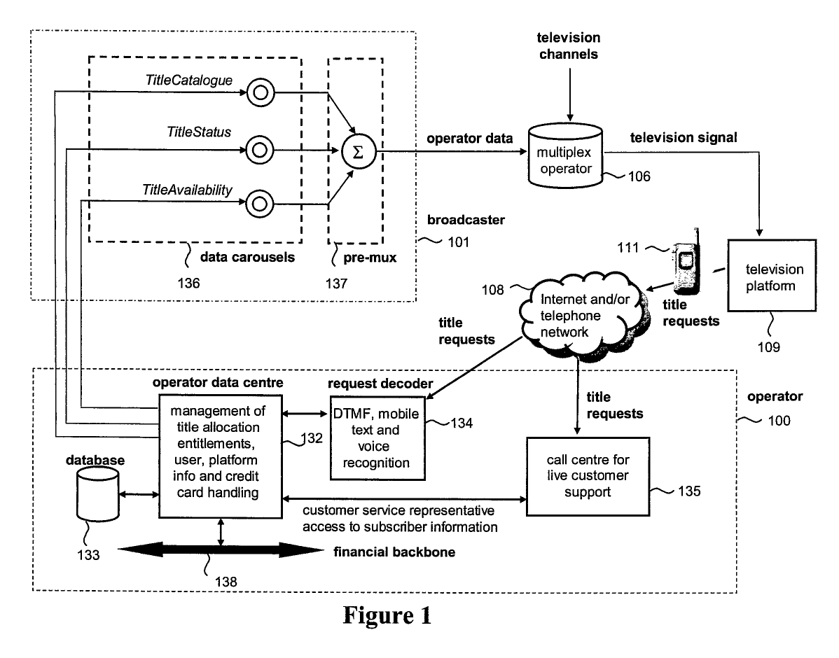

FIG. 1 shows an improved television system for allowing users to order DVDs or other media for delivery via a non-electronic route. This has a DVD title service operator 100, a broadcaster 101, a communications network 108 and a plurality of television receiver platforms 109. The operator 100 has a data centre 132 that receives and aggregates users' title requests across a plurality of telephone networks 108 via a request decoder 134 and a manned call centre 135. The request decoder 134 may extract users' account and requested title identities according to a plurality of means including via recognition of dual tone multiple frequency (DTMF) tones generated by users 118 pressing telephone 111 numeric keys; by receipt and parsing of SMS text messages received from users' mobile telephones 111 and via automatic voice recognition of users' speech. The request decoder 134 is further adapted to determine users' calling line identifications (CLI) in order to look up their account numbers. Alternatively, users can interact with the operator 100 via the call centre 135. In any case, all information received from the user is passed to the data centre 132, which manages and stores user details on a database 133, communicates transactions to credit card and other payment facilities via a financial backbone 138, and broadcasts the catalogue title information, subscriber status logs and updates to television platforms 109 over the air via a broadcaster 101.

The broadcaster applies the respective operator data streams from operator 100 to data carousel 136 and pre-multiplexes together for transmission to a multiplex operator 106 for combination with other television channels and services. Data is preferably transmitted as one or more modules using the so-called DSM-CC (Digital Storage Media Command and Control) object carousel 136. The DSM-CC carousel is a data stream transmitted by the broadcasting station alongside television audio-video service data, where each module comprises executable code and/or data components of one or more data sets that may be downloaded by television receiving platforms.

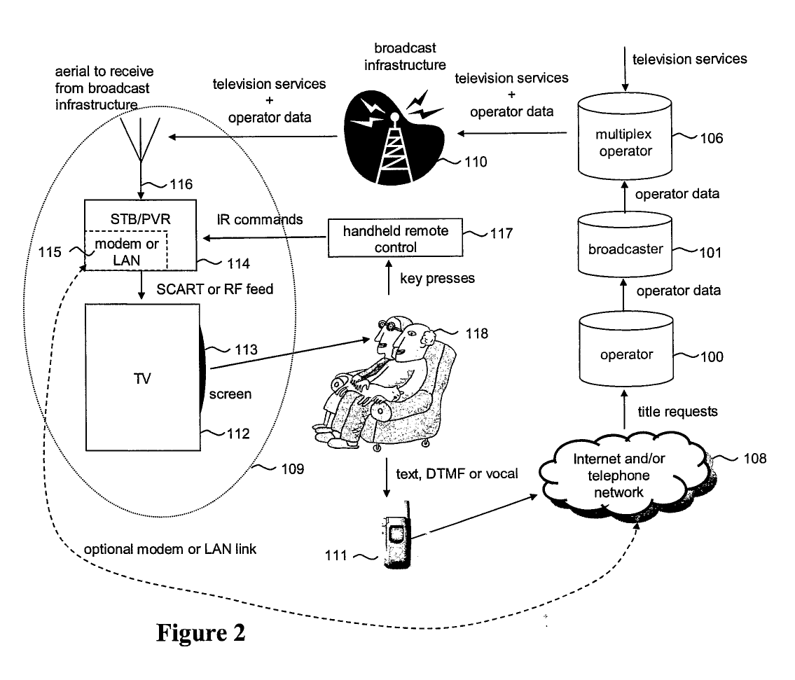

FIG. 2 shows how data streams are broadcast via an appropriate broadcast infrastructure 110 using the DVB (Digital Video Broadcasting) family of public satellite (DVB-S), and/or cable (DVB-C) and/or terrestrial (DVB-T) broadcast formats to television platforms 109 where a manual means, such as a telephone call, composure of a mobile telephone SMS text or by speaking a request may be employed to communicate information back to operator 100. The platform may comprise a set-top-box (STB) or personal video recorder (PVR) 114 that receives television services, including the data streams from the service operator 100, via an aerial, satellite dish or cable socket 116 and connects to a television 112 for display purposes via a screen 113 to one or a plurality of television users 118. Users 118 communicate with the service operator 100 by speech or by pressing key sequences via a cordless, wired or mobile telephone 111 that communicates with the service operator 100 via a data and/or telephone network 108.

Platform 109 may have several embodiments whereby the functionalities of the STB or the PVR 114 may be integrated, or partially integrated, with the television 112 and/or display screen 113. In another embodiment the functionality of the STB or the PVR 114 is performed by a personal computer (PC) and the television's display screen 113 function is performed by a display monitor. In another embodiment, the aerial 116, STB 114, television 112, remote control 117 and screen 113 functionalities are integrated into a single handheld device such as a cordless or mobile phone, PC notebook, media player or video jukebox, palmtop computer or a personal digital assistant (PDA). In a yet further embodiment, platform 109 may comprises a modem or a local area network (LAN) transceiver 119 where data is exchanged between the service operator 100 over the internet 108 instead of via the DVB broadcast infrastructure 101 and 106. In a yet further embodiment platform 109 may be linked using wireless means, such as by using the WiFi or IEEE 802.11a/b/g standards, to the internet via a domestic wireless access point (not shown). Alternatively or additionally, platform 109 may also be linked to the internet using a wireless wide area network such as via a GPRS (General Packet Radio Service) or 3G (third generation) mobile telephone network. In each embodiment, platform 109 may continue to receive television channels and other services by broadcast means via infrastructure 110 and aerial 116. Alternatively or additionally, platform 109 may also receive television channels, programmes and other services via the Internet 156. Preferably the LAN transceiver 115 connects to STB 114 via a connection interface such as the industry standard PCMCIA (Personal Computer Memory Card International Association) “PC Card” 68-pin Type I, II or III interface or the USB (Universal Serial Bus) interface and may be removed by the user from the platform.

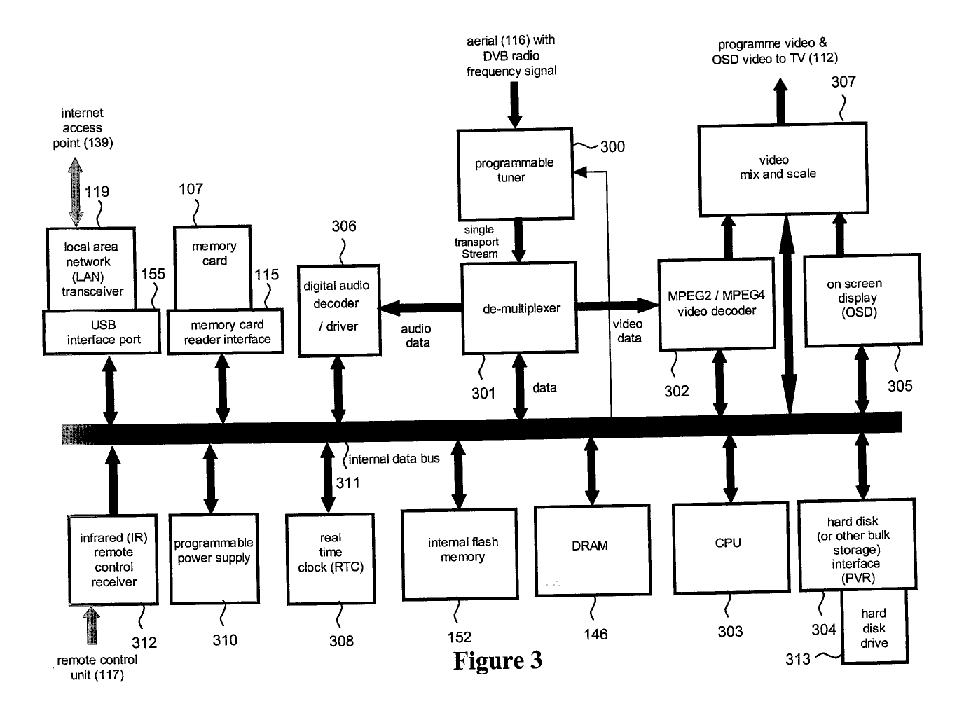

FIG. 3 shows the internal functional elements of a typical digital STB 114 designed to receive and decode DVB television transmissions. This has a central processing unit CPU 303 coupled to volatile memory, such as DRAM, 146 and internal, non-volatile (flash) memory 152 that are integral to and not removable from the platform. The integral flash memory 152 contains amongst other things, digital signatures and keys, so that its contents must not be readable across the STB's connection interfaces to external devices 155 and 115. An external memory card 107 may be connected to the STB via one or more memory card reader interfaces 115. Preferably the STB incorporates a single reader interface 155 that is simultaneously compatible with multiple memory card formats such as Memory Stick, Secure Digital (SD), Smart Media (SM) and Multi Media Card (MMC).

Communication between the CPU and the other blocks is via one or more internal data buses 311. The CPU receives user commands from remote control 117 via an infrared receiver 312. When the STB is in standby, a real time clock (RTC) or countdown timer 308 controls when portions of the STB are to be powered up. In the preferred embodiment, when the STB is in standby mode between downloads, the CPU and memory operate in a low power mode with all other blocks except an RTC 308, IR receiver 312 and programmable power supply 310 powered off completely. The power supply is controlled by the CPU to apply and remove voltage rails to one or more of the other blocks depending on whether the STB is required to enter an active, standby or download state. The STB may have personal video recording (PVR) features and contain some form of bulk storage interface 304 connected to a hard drive 313 for storage of video and/or clips. This would typically be an ATAPI or SCSI hard disk interface, but any popular bulk data storage interface standard may be implemented.

The STB contains a programmable tuner 300, which is connected to receive DVB-T broadcasts via an aerial 116. Additionally or alternatively, the tuner may receive cable and satellite transmissions. By means of the internal data bus, flash based loader firmware programs tuner 300 and de-multiplexer 301 to receive and decode any MPEG2 transport stream (channel) present at aerial 116, including the streams (channel) carrying the service operator's 100 transmissions. The tuned transport stream is applied to a de-multiplexer 301, where elementary audio, video and data streams can be extracted. Video data streams are applied to the MPEG-2 and/or MPEG-4 video decoder 302. The output of this decoder is then combined with the on screen display OSD 305 to provide the video signal to the television 112. The OSD is responsible for displaying all graphical outputs to screen 113 of the applications. The video mix and scale function are capable of scaling the decoder video in order to present a reduced size live video display anywhere on television screen 113. Preferably, the STB is connected to a removable wireless (such as according to the WiFi or IEEE 802.11a/b/g standards) or Ethernet cable LAN transceiver 119 via the Universal Serial Bus (USB) interface port 155.

Many of the functional elements described in FIG. 3 may be combined on a single large-scale integration (LSI) silicon-component such as STMicroelectronics' STi5100 chipset. In the case of a digital television receiver all the functions described in FIG. 3 are resident within the television chassis.

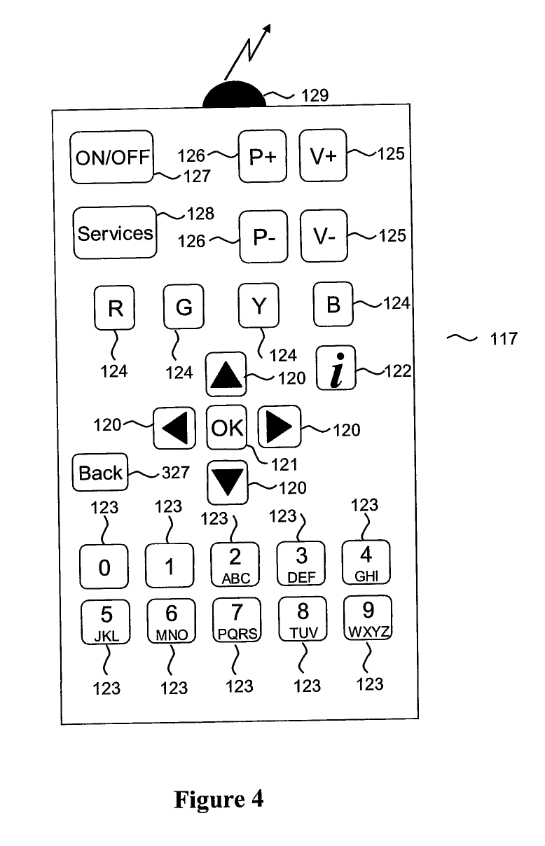

A handheld remote control 117 is provided for controlling the television platform 109. An example of a suitable remote control handset 117 is shown in FIG. 4. Remote control 117 sends commands to platform 109 preferably by wireless means. In the preferred embodiment, the handheld control 117 uses an infrared transmitter 129 to send commands to platform 109 that correspond to keys as they are pressed by the user, where such keys include: platform power ON/OFF toggle 127, volume up/down 125, channel up/down 126, red/green/yellow/blue fastext keys 124, up/down/left/right cursor keys 120, OK/select key 121, 0-9 numeric keys 123 labelled with multiple tap alphabetic characters, a “Back” key 327 for reversing out of a user interface selection and a “Service” key 128 for causing the platform's service guide options 140 to be displayed as later described in this invention. Alternative embodiments for handheld control 117 may include any platform where keys are appropriately labelled to correspond to that of a television control platform, such as may be achieved using a mobile or cordless telephone, a standard “QWERTY” keyboard, a personal digital assistant (PDA), or a touch sensitive, handheld display where portions of the display are marked with labels corresponding to television control commands.

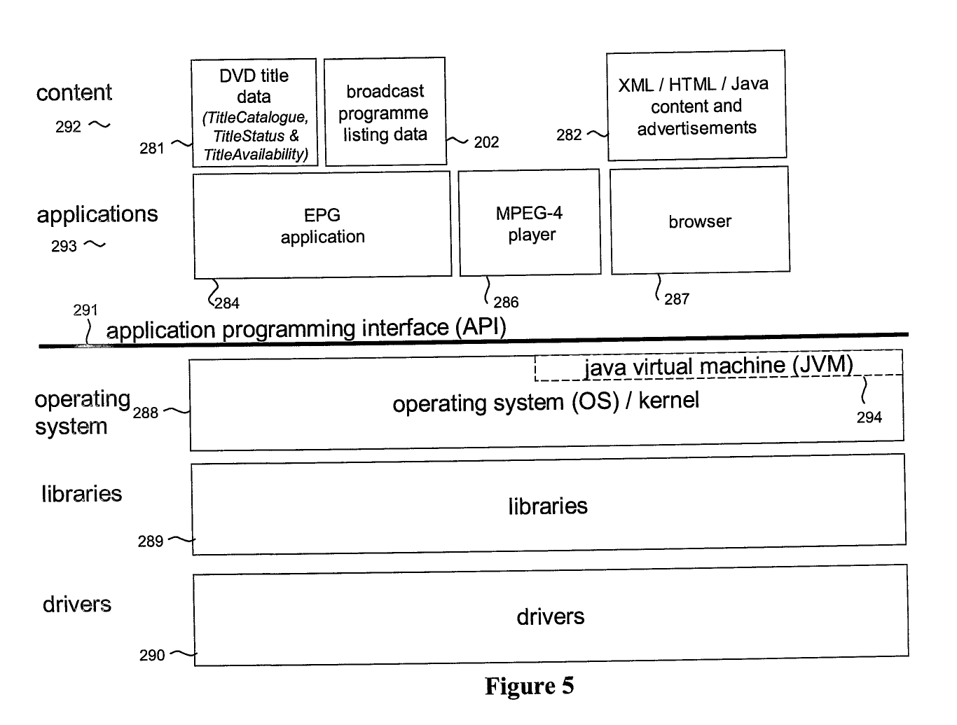

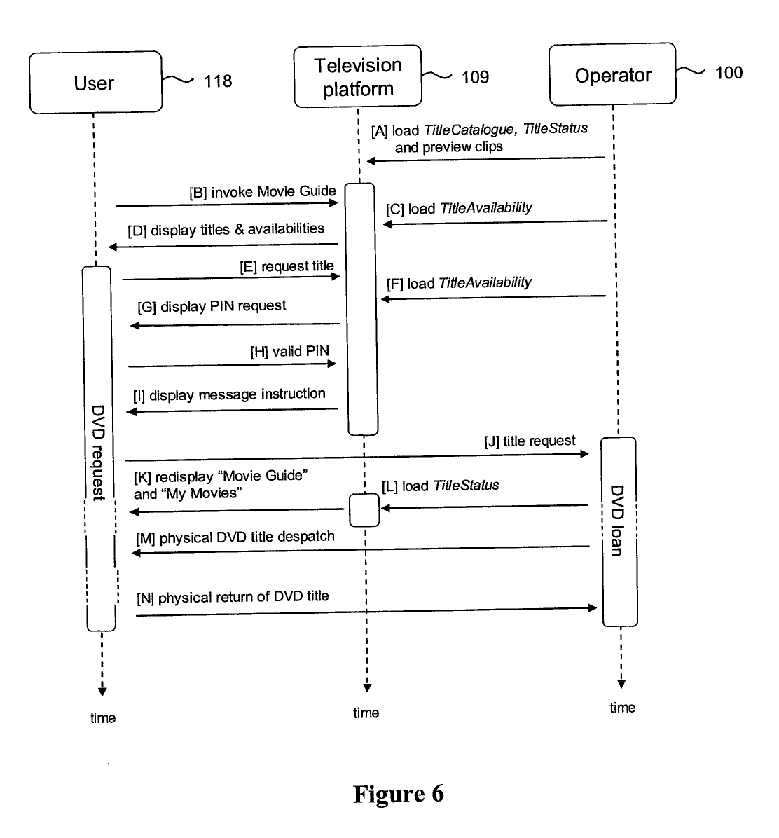

FIG. 5 shows the structure of programme application software, data and service content stored for the preferred embodiment of television platform 109. Applications, including the IPG application 284, communicate with an operating system 288 and code libraries 289, graphics and data communication drivers 290 and other components via a standard application programming interface 291. The IPG employs a browser 287 to display marked up content and a software decoder 286 to play MPEG-4 and other audio-video formats. Each application 293 may have associated with it data or content 292 which it may process. Preferably all applications are adapted to run over Java, or some other form of virtual machine 294. FIG. 6 shows the overall communication processes between the various entities of the user, the television platform and the operator as employed by the system of the invention. Each process is referred to hereafter by its label in brackets. The platform loads the tables TitleCatalogue, and TitleStatus from broadcasts 171 and 173 respectively prior to interaction with a user as shown as [A] in FIG. 6 and described below.

Operator Catalogue: TitleCatalogue

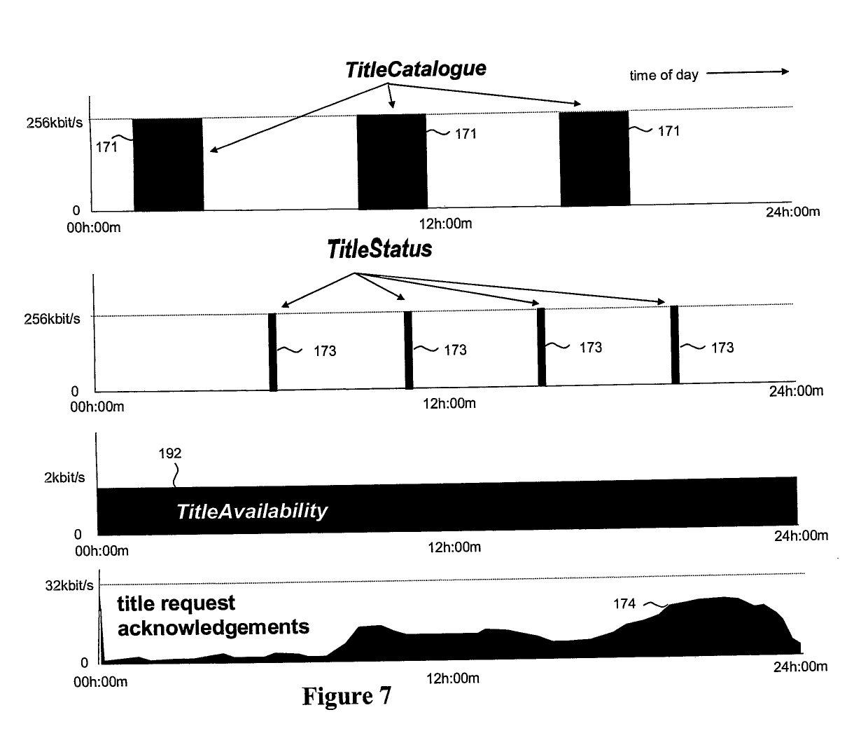

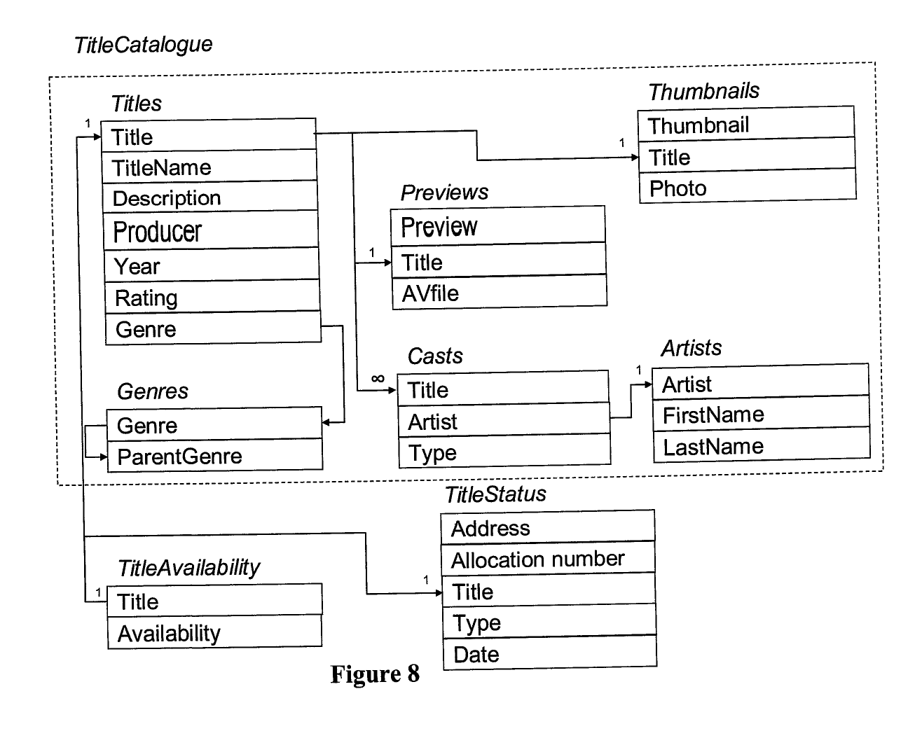

FIG. 7 shows the timing and relative bandwidths of the broadcast stream components of the operator data broadcasts. The platform receives the title catalogue data and telecast programme data a number of times within data broadcast as bursts 171 during each day. In the preferred embodiment, the IPG application 284 causes the platform 109 to tune to and download into semiconductor dynamic random access memory (DRAM) 146, from three daily broadcasts 171 of title catalogue data. FIG. 8 shows the preferred embodiment where the catalogue data 281 is composed as a relational database TitleCatalogue comprised of a number of linked tables: Titles, Thumbnails, Previews, Genres, Artists and Casts.

Titles contains a record for each DVD title in the catalogue. Each record contains a numeric identifier, Title, a title name (e.g. “Master and Commander”) TitleName, a description of the title in a mark-up language suitable for rendering the description on screen Description; details of the title's production company Producer; the year the title was produced Year; and a code Rating identifying the title's parental rating (e.g. “12”, “18”).

| Titles attributes | Type | Description |
|---|---|---|
| Title | Long integer | Title identifier |
| TitleName | Short text | Title name |
| Description | Long text | Hypertext description of title |
| Producer | Short text | Producer and studio |
| Year | Short integer | Year title was made |
| Rating | Short integer | Parental rating |

The table Thumbnails contains a collection of thumbnail photographs that correspond to specific titles via an indexed link.

| Thumbnails attributes | Type | Description |
|---|---|---|
| Thumbnail | Long integer | Preview identifier |
| Title | Long integer | Title identifier |
| Photo | Photo object | Photo (e.g. JPEG or PNG) |

The table, Previews, may contain trailer audio-video clips, A Vfile, for one or more of the titles.

| Previews | | |
|---|---|---|
| attributes | Type | Description |
| Preview | Long integer | Preview identifier |
| Title | Long integer | Title identifier |
| AVfile | AV object | Video clip (e.g. MPEG-2 or MPEG-4) |

The table Genres contains genre classification attributes (e.g. “movie”, “children”) for one or more of the titles:

| Genres attributes | Type | Description |
|---|---|---|
| Title | Long integer | Title identifier |
| Genre | Short integer | Short identifier |

The table Artists contains details for various types of artists.

| Artists attributes | Type | Description |
|---|---|---|
| Artist | Long integer | Artist identifier |
| FirstName | Short text | Artist's first name |
| LastName | Short text | Artist's last name |

The table Casts contains details by title for artists, identifying their role for a given title:

| Casts attributes | Type | Description |
|---|---|---|
| Title | Long integer | Title identifier |
| Artist | Long integer | Artist identifier |
| Type | Short integer | Type of casting (e.g. actor, director, |
| | | producer) |

User Status Broadcasts: TitleStatus

Each user that subscribes to the DVD club is given a fixed number of title allocations. A single DVD may be requested for each allocation. The user may keep the requested DVD for as long as he or she likes, but cannot receive a title against an allocation until the previously allocated title has been returned to and received by the operator. At pre-scheduled times the operator broadcasts a table, TitleStatus, containing the statuses of each of each subscriber's title allocations identifying the last title sent and its despatch or receipt according to the following attributes.

| TitleStatus attributes | Type | Description |
|---|---|---|
| Address | Long integer | Platform or STB machine address |
| AllocationNumber | Short integer | Allocation number |
| Title | Long integer | Title identifier |
| Type | Boolean | Flag to indicate whether the Date |
| | | refers to date of despatch or date of |
| | | receipt. |
| Date | Date | Date title despatched or received by |
| | | operator. |

Given the large volume of subscribers and limited bandwidth availability on most networks, the TitleStatus attributes are broadcast tightly packed to maximize bandwidth and storage efficiency. During download of this data, the television platform 109 parses the TitleStatus table in real time and filters on Address, so that only records whose Address attribute matches the platform's address are downloaded. This saves on memory. All the records in the TitleStatus table are broadcast daily, preferably overnight, to keep each subscriber informed of his/her allocation status. Additionally, a subscriber's status record is updated and broadcast for downloading by his/her television platform in real time at the end of each session where he or she contacts the operator to make a title request (see later).

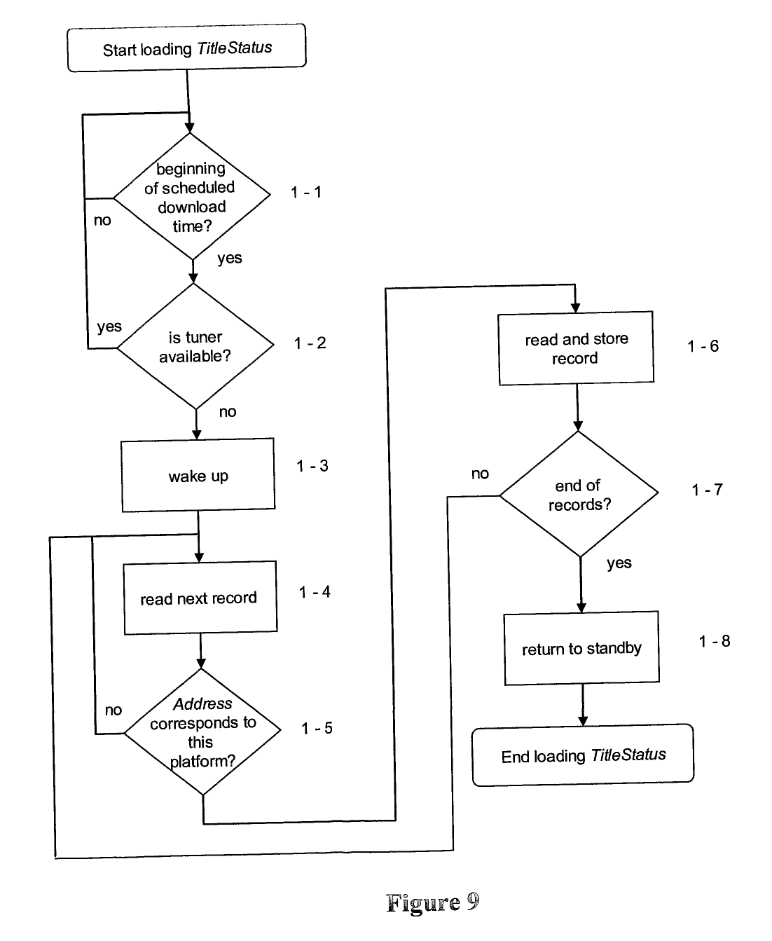

The process for downloading records from the scheduled broadcasts of TitleStatus is described in FIG. 9. The television platform employs a real time clock or count down timer 308, as shown in FIG. 9 and waits for the beginning of a broadcast 173 (1-1), at which time the platform verifies whether a programmable tuner is available (1-2). If the platform is in standby, it wakes up (1-3) and downloads each message address (1-4, 1-7) to determine whether the record is relevant to the platform (1-5). Relevant records are stored in memory (1-6) and, if the platform was in standby prior to the download it returns to standby (1-8) at the end of the download process.

Availability Updating: TitleAvailability

Upon display of the Movie Guide areas 160 and 169, certain titles listed within TitleCatalogue may not be available for request because they are momentarily unavailable to the operator and cannot be despatched to users. It would be undesirable for a user to be caused an inconvenience of requesting a title by placing a telephone call or sending an SMS text message if it is unavailable. Consequently it is useful for a Movie Guide to maintain an up-to-date record of availability for each title so as to selectively highlight or display only those titles that are momentarily available for a user to request. Further it would be useful to annotate each title with descriptive information indicating how long a user may have to wait until its delivery, e.g. “Next day” or “7 days”, if requested. However, no bi-directional link may exist between the television platform and the operator during the period that the user consults the Movie Guide with the result that no means may exist for the user's television platform to be updated with availability information via the internet or a telephone. Even in the case of the television system of FIG. 2 for example where a modem is fitted, it may still be undesirable for a modem connection with the operator to be activated for reasons such as cost of telephone calls, interruption of normal telephone services or because the modem may be unconnected to the network 108.

Given that an operator's title inventory is constantly fluctuating as a function of title returns from and title issues to users it would clearly be beneficial for the Movie Guide 160 to be quickly updated immediately prior to its use and upon a user making a request for a title, but prior to the user making a telephone call or placing an SMS text message. A method of complementing the periodic broadcasts of a title catalogue with continuous broadcasts of title availability information is described below. Availability for each title is expressed as an integer code, Availability. Each value of Availability is packed together un-delimited, into a single, compact, contiguous sequence to form a data block, TitleAvailability, which operator 101 broadcasts periodically, every few seconds. For a given title identity, TitleId, the starting bit position of its corresponding value, Availability, is encoded by the operator and decoded by the platform as 1+B*(TitleId−1) where B is the number of bits used to express Availability. In the preferred embodiment, Availability, has four values 0: “not available”, 1: “in stock—1 day to delivery”, 2: “1 week to delivery” and 3: “coming soon” and consequently occupies 2 binary bits of information (B=2). Consequently, the availability of a 4,000 title database can be expressed within a single 1 kilobyte data block. The operator periodically updates TitleAvailability and re-broadcast it every 4 seconds continuously 24 hours per days (refer to 192 in FIG. 7).

DVD Movie Guide User Interface

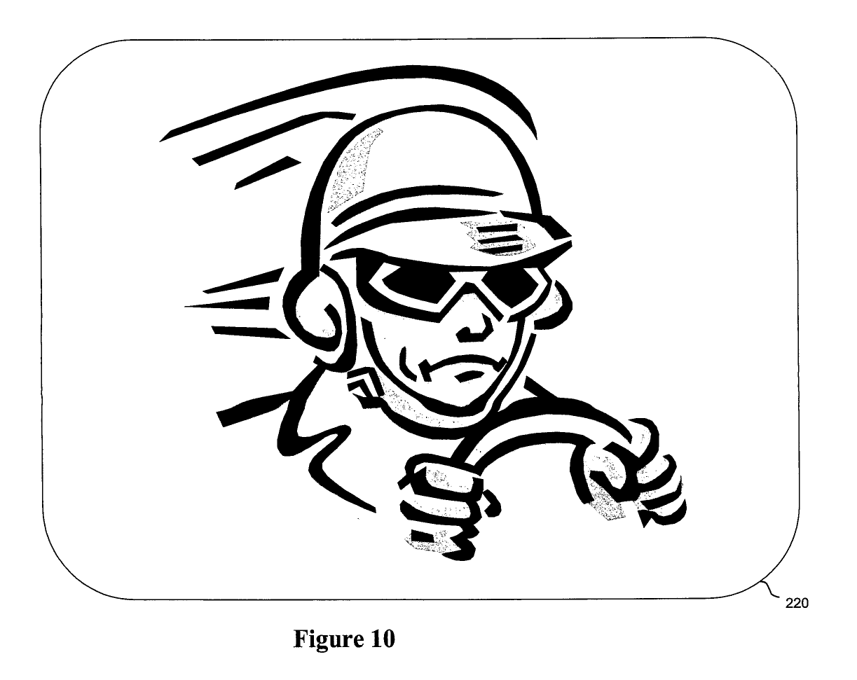

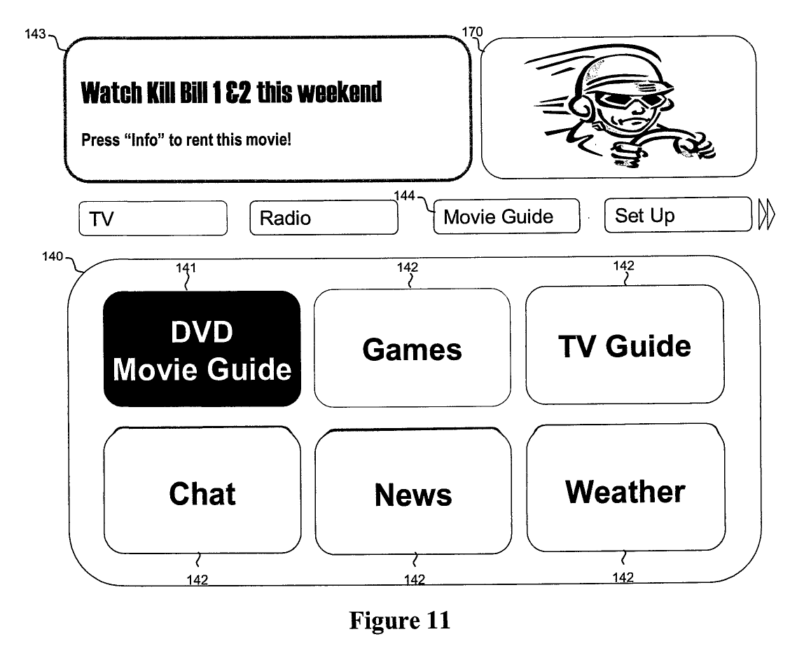

While watching full screen television, as shown in FIG. 10, a user may invoke the IPG application 284 to browse and request a DVD title by pressing the Services key 128 on the remote handset 117, shown as [B] in FIG. 6. Depending upon how the IPG user interface is arranged an intermediate service guide may appear, as shown in FIG. 11, where the user presses arrow keys 120 to direct movement of a cell highlight between cells 142 within an on screen menu area 140 to focus upon a cell 141 that corresponds to the DVD titles operating mode of the IPG application and to select said cell 141 by pressing the OK key 121.

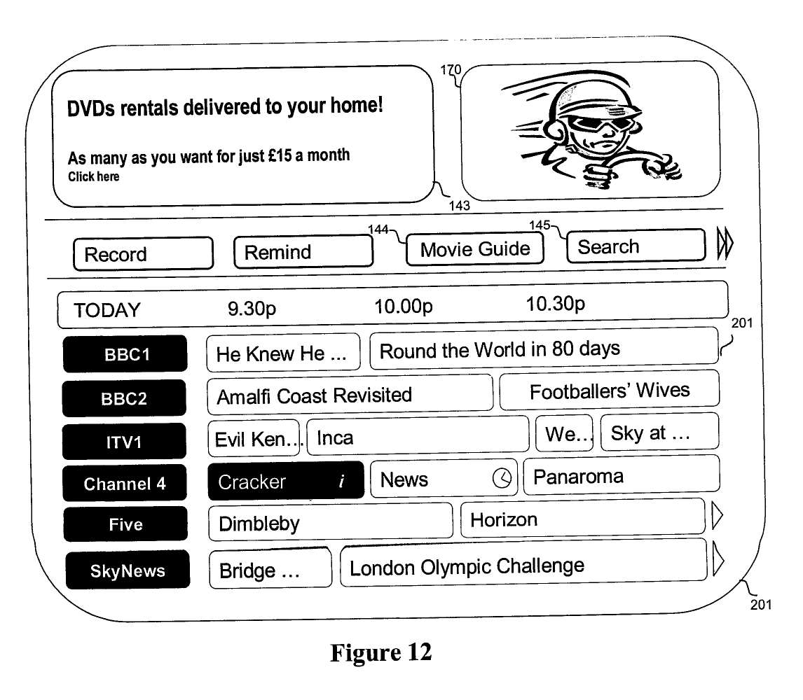

The user may press a hot key such as one of the colour keys 124 on remote handset 117 to enter the DVD operating mode, where an indicator of said mode is displayed as a label 144 on the television screen. Alternatively, the user may press a hot key corresponding to the label 144 to enter the IPG DVD operating mode from another mode of IPG operation, such as from a telecast programme guide representation 201 where broadcast television programme titles, their start times and channels are depicted on screen, as shown in FIG. 12. Alternatively, the user may invoke the IPG application 284 by pressing a key in response to a message displayed within an advertisement panel 143 that is displayed alongside the programme cells.

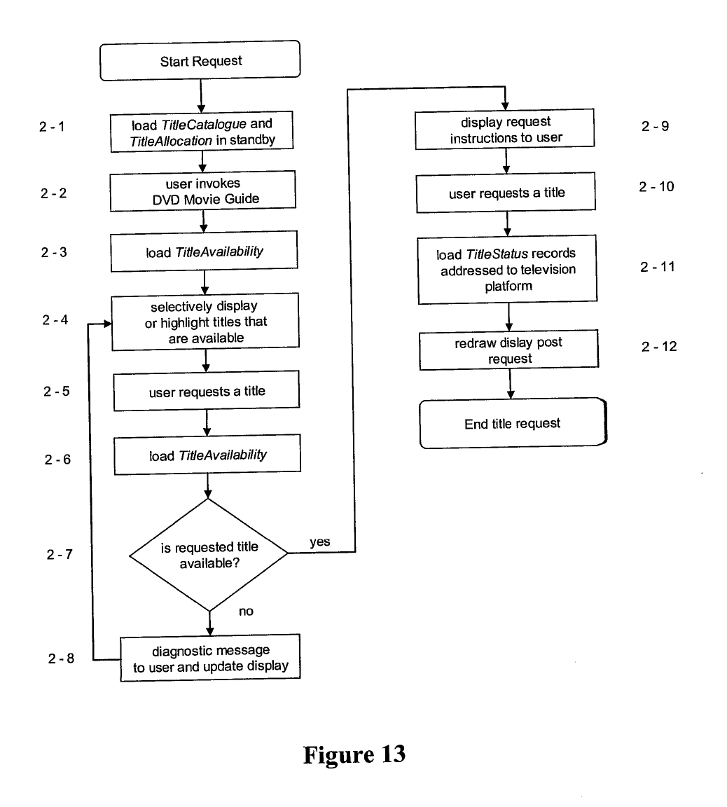

FIG. 13 shows the main screen for the IPG in DVD title operating mode. A first “Movie Guide” area of the display 160 contains a plurality of cells 161 that each correspond to a DVD title. Each cell 161 is preferably displayed as either an inset thumbnail picture 162 to identify a title or is inset with the name of the title itself (not shown). The user presses arrow keys 120 to direct movement of a cell highlight 164 around cells 161 in order to move focus to a cell of interest. The highlight may be any visible means of distinguishing the cell in focus 164 from the other cells 161, such as by changing the cell's background colour or pattern or border or animation. The thumbnails give the user the convenience of being able to recognise a title by its pictorial DVD cover, such as is likely to be familiar to many users from advertising and movie reviews in the press. A scroll marker arrow 163 appears on screen to inform users if additional hidden cells exist outside the area 160 in the direction of the marker arrow. The user may scroll the hidden cells into the visible area 160 by pressing the cursor keys 120 as if to move the highlight outside the area in the direction of the arrow 163.

Responsive to the user focussing on the title cell 164 a second notes area 169 displays simultaneously the title name corresponding to the cell, notes and icons describing the title and an indication of time to delivery if the title were to be requested immediately by the user. An info icon 205 is displayed to indicate to the user the possibility to cause additional information to be displayed by causing the area 169 to increase in size by pressing an information key 122 on the remote handset 117. The responsive notes area 169 is useful to a user because it allows a user to read further information about just the title cell in focus while maintaining the other title cells on screen for browsing to later.

A third “My Movies” area 165 is displayed on the same screen alongside the first and second areas to display cells 166 that correspond to the statuses of each of his or her title allocations. Each cell 166 preferably contains inset within it a thumbnail picture 167 to describe the title to which it corresponds or, alternatively or additionally, a title name is instead displayed. Each cell 166 preferably contains a message 168 describing the allocation's status. Message 168 may indicate when a requested title was despatched to or received by a user. Status message 168 may contain some other helpful message to the user such as, for example, to indicate whether the allocation is available for request of an additional title. A “My Movies” area, simultaneously on screen adjacent to the Movie Guide area 160 and title notes area 169, is useful because it allows a user to comprehend immediately what titles he or she currently holds and what actions may be required prior to requesting a title.

Status cells 166 may be marked or shaded differently to other status cells in order to highlight a particular status message, such as the possibility to request a title against a cell allocation, such as illustrated by the patterning 175. The user may further press arrow keys 120 to navigate focus from a cell in the Movie Guide area 160 to an allocation cell 166 in the My Movies area 165, responsive to which the notes area 169 displays simultaneously the cell's title name, descriptive notes and status information. A fourth area 170 displays in reduced scale the currently viewed television programme or channel prior to the user invoking the IPG DVD titles mode of operation and, simultaneously, the television programme's sound is maintained. This is convenient to a user because it allows him or her to stay in touch with a television programme while browsing the Movie Guide.

Title Request Process

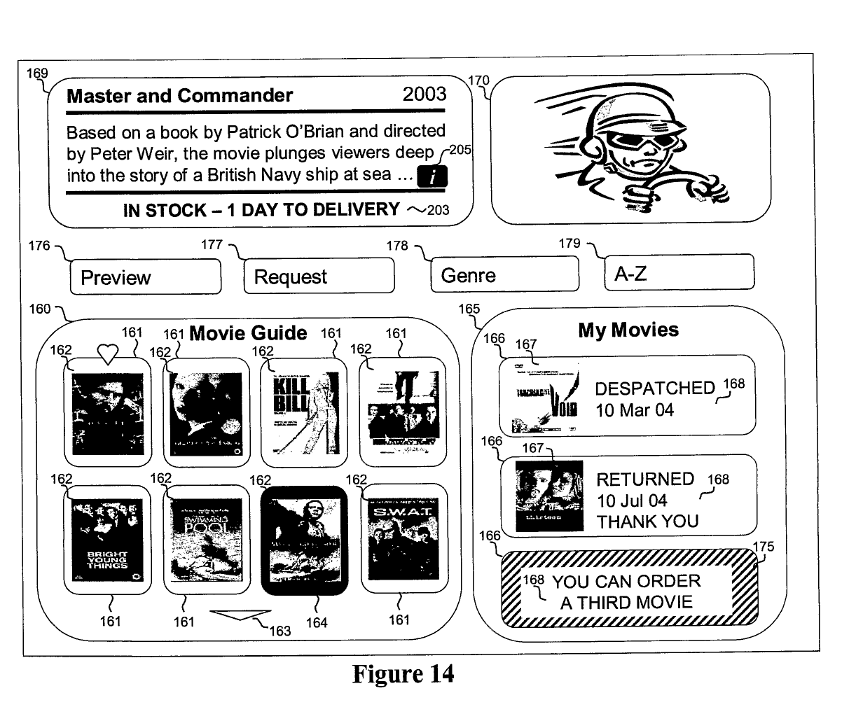

FIG. 13 describes the overall process steps employed when a user requests a title from the operator. Off-line, in advance of a user's interactive session with the television platform the title databases, TitleCatalogue and TitleStatus, are downloaded by the platform (2-1). The loading of TitleStatus is previously described and illustrated in more detail in FIG. 9. At some point during interactive session the user invokes the DVD movie guide user interface (2-2) within the IPG as illustrated in FIG. 14 and previously described and shown as [B] in FIG. 6. The platform blanks or freezes the video picture in graphic 170 and mutes the sound. The platform tunes to the operator's carousel data stream containing the TitleAvailability data 192 and downloads the TitleAvailability data block (2-3), as shown by [C] in FIG. 6.

The platform joins the tables TitleCatalogue and TitleAvailability at the attribute Title and selectively displays to the screen only cells 161 and 164, which correspond to available titles (in other words where Title>Availability>0 according to the numbering scheme previously described for Availability) (2-4), as shown by [D] in FIG. 6. The program notes area 169 is further annotated with a text description 203 or icon that corresponds to each of the various values of Availability (e.g. 1=“in stock—1 day to delivery”). It can be readily seen how, in other embodiments, cells 161 and 164 may be similarly annotated.

Where a title is available and not currently requested or allocated to the user, a labelled area 177 is displayed as “Request” or similar to confirm the availability of a request action. The user requests a DVD title (2-5) by pressing the hot key 124 associated with the displayed request cell 177 to request the DVD to be mailed by the operator to the user, as shown by [E] in FIG. 6. Given that some time may have elapsed between a user making a request and when title availability was first determined (2-3) after invoking the Movie Guide (2-2), the process step (2-3) is repeated when a user makes a request (2-6). The IPG looks up TitleAvailability to determine whether the title is still available or has changed (2-7), as shown by [F] in FIG. 6. If its availability has changed, a message of explanation is displayed and the cells 161, 164 and annotation 203 are redrawn accordingly (2-8).

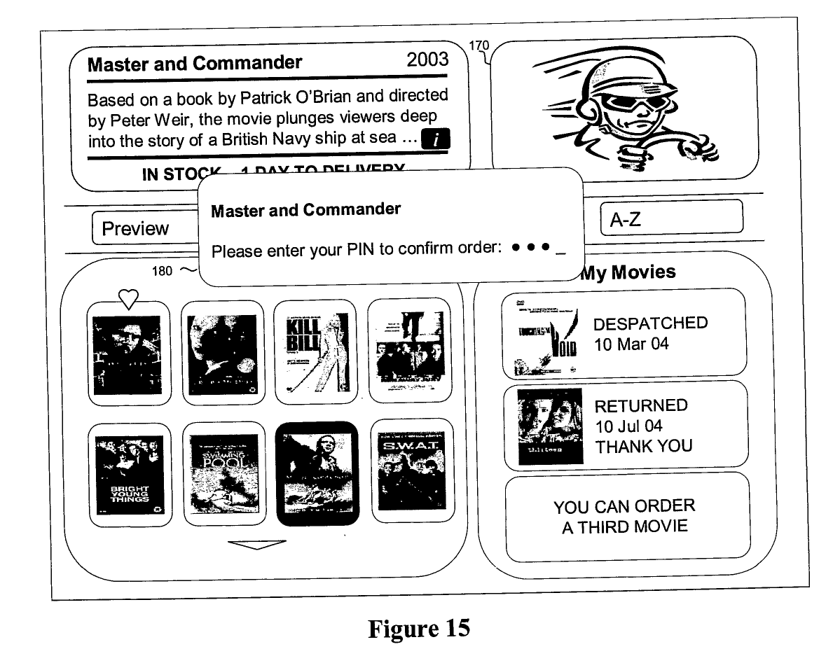

Turning to FIG. 15 a message and prompt 180 may be displayed to the screen to require the user to key in a valid personal identification number (PIN), as shown by [G] and [H] in FIG. 6. Where the television platform is connected via a return path to the operator data centre 132, the user's title request communication steps [J] through [L] are handled automatically. In the embodiment described, the television platform does not have a back link to the operator and so a manual method of communication is employed from the user to the operator. This is described below for the case where the user composes and sends a SMS text message to the operator using a mobile telephone 111.

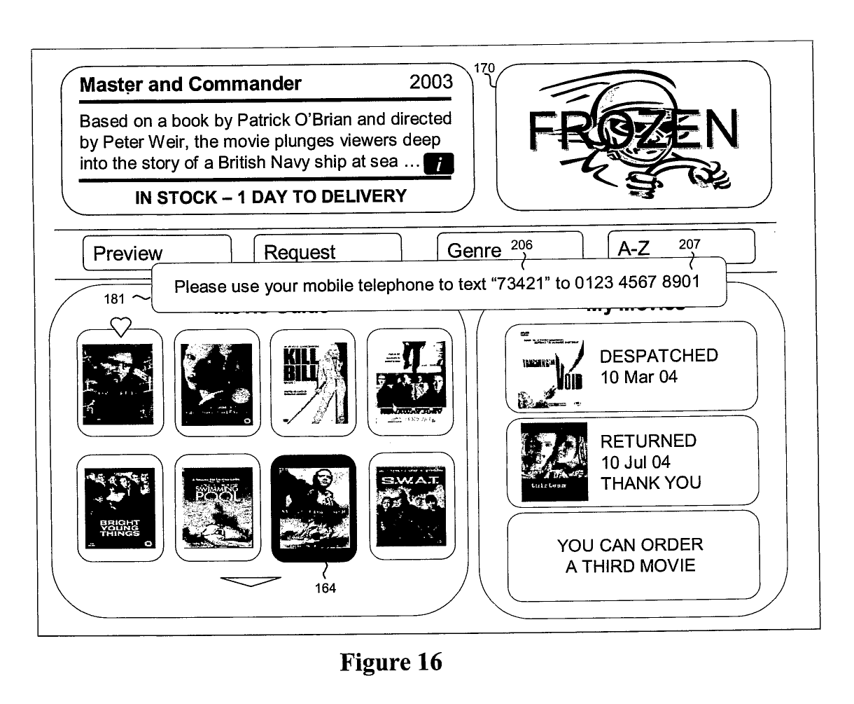

Upon receipt of valid PIN, FIG. 16 shows that the IPG freezes the picture in graphic 170 and displays to the user an instruction 181 to send a SMS text message containing the title's identity 206 to the operator's 100 SMS text telephone number 207, as shown by [I] of FIG. 6 (2-9). Additionally, the IPG may request that use to add his/her account number (if call line identification is not employed by the operator's request decoder 134, see below) and PIN to the text for security (in which case the dialogue [G] and [H] are not performed). The user composes the SMS text message using mobile telephone 111 according to the instruction [I] and sends to the operator's request decoder 134, as shown by [J] of FIG. 6 (2-10). The request decoder communicates the title identifier and SMS text caller identification to the operator data centre 132.

Referring to FIG. 13, the IPG commands the tuner 300 and demultiplexer 301 to tune to and acquire the transaction data stream. The IPG filters incoming packets on the operator data stream whose address header matches the television platform's address, and waits to receive an acknowledgement of the request from the operator. In the embodiment described, users pre-register their mobile telephone numbers with the operator 100. The operator looks up its database 133 to determine the user's account number, the television platform address, whether the title is available to despatch and verifies that the user's account details are valid and that he or she has a free title allocation. The operator confirms the request [J] by broadcasting back to the television platform 109 the user's updated title status [L] for each of the user's 3 allocations via data carousel 136, pre-mux 137 and multiplex operator 106. The IPG filters, downloads and decodes the packet containing the title status records addressed to the television platform and stores them in memory 281 (2-12).

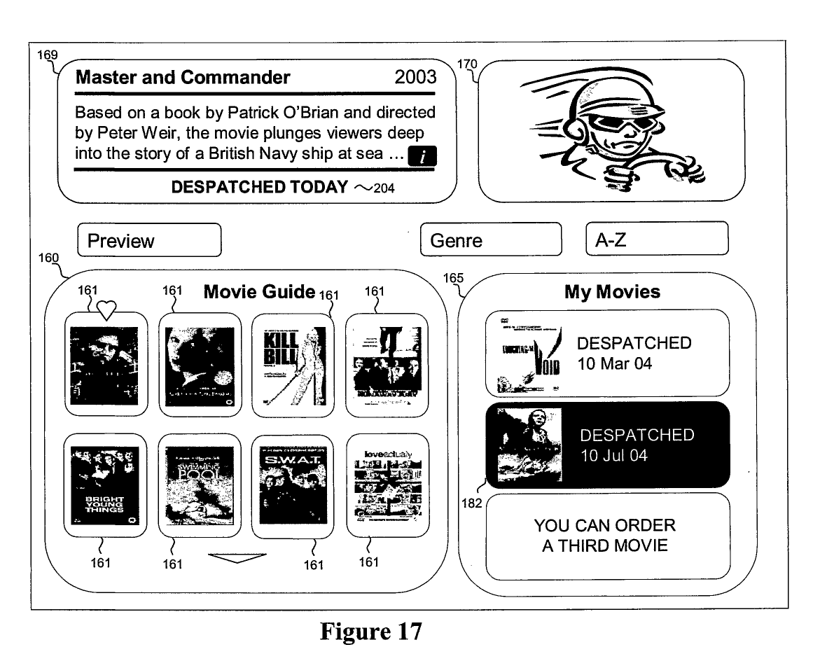

The IPG removes the message 181 (2-12). If the requested title is in stock, it can be despatched immediately and the user has a free title allocation 166 then the cell 164 corresponding to the requested title is transferred from the Movie Guide area 160 to the My Movies area 165 as depicted by 182 in FIG. 17. The remaining cells 161 are further redrawn to form a contiguous block, and the request hot key label 177 is withdrawn. Finally, cell 182 is placed in focus with further notes relating to the allocation 204 displayed in area 169 (2-12), as shown by [K] of FIG. 6.

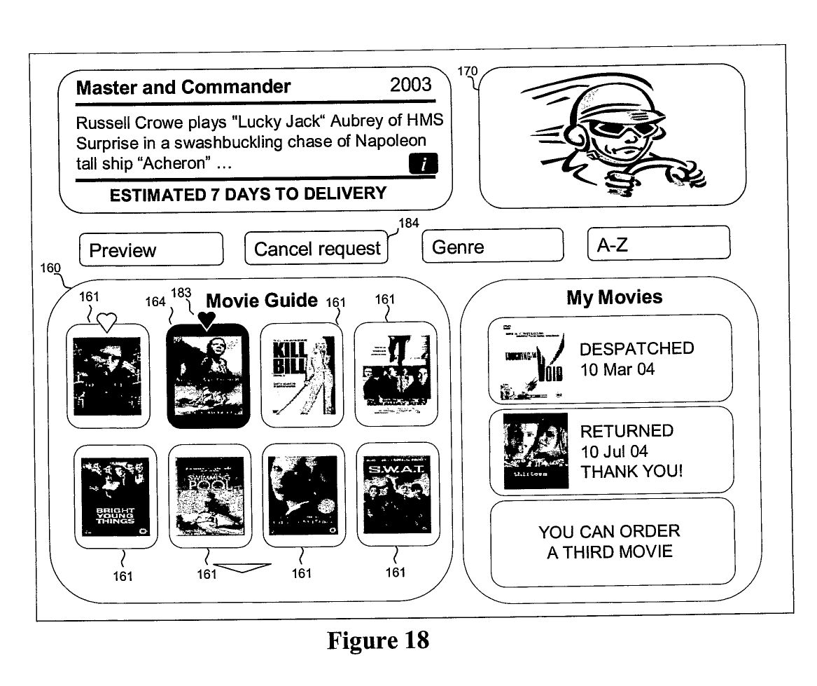

Referring to FIG. 18, if the requested title cannot be despatched immediately because it is not in stock or because the user does not currently have a free allocation, the IPG redisplays the cell title in focus 164 with a marker 183 to indicate that it has entered a queue of requested titles. The IPG then redisplays the focussed cell and marker in a different position in the Movie Guide area 160 such that the cell is visible and located immediately in a prominent position upon a user visiting the Movie Guide area 160. At such future time when the operator determines that the requested title is available to be despatched to the user, the operator despatches the title to the user and broadcasts 173 a TitleStatus record to indicate that the title is despatched to the user. When in standby or not in use, the IPG downloads the records within the TitleStatus table pertaining to the television platform address [A]. Upon next entry by a user the IPG clears the requested cell marker 183 and moves display of the requested title 164 to the My Movies area 165 as depicted by 182 in FIG. 17. Finally, the operator despatches the DVD title to the user and the user views and returns it to the operator, as shown by [M] and [N] respectively of FIG. 5.

There are several aspects of the aforesaid method of exchanging request details between user and operator that are useful. Firstly, the user has no need to communicate the status of the request to other users in the home because the status information is readily visible on the television display. Further, the television platform 109 does not in itself have to be connected to a bi-directional data network in order to receive and display the status information and, consequently, does not subject the user to the inconvenience of having to connect the platform 109 to the telephone or broadband internet networks, nor to install or configure it to link to a network interface, such as for example to a wireless internet access point 139. In addition, a user is immediately informed in a visual manner of the status of his or her request and is not required to listen to or take down notes from spoken information on the telephone. If the title is not immediately available, the IPG displays the title as a member of a queue of requested titles, which is periodically updated with new information from the operator regarding the queue's status so as to keep the user regularly informed of the status of his or her requests.

In embodiments where the platform has a single tuner 300 and de-multiplexer 309, the platform tune must tune away temporarily to the host transport stream containing broadcasts 192 and 174 prior to performance of the data downloading steps (2-3), (2-6) and (2-11). Prior to each said step the platform blanks or freezes the video picture in graphic 170 and mutes the sound. After each said step the platform re-tunes to the service stream containing the previously displayed television channels and restores its video to the picture in graphic 170 and restores the sound.

Preview Process

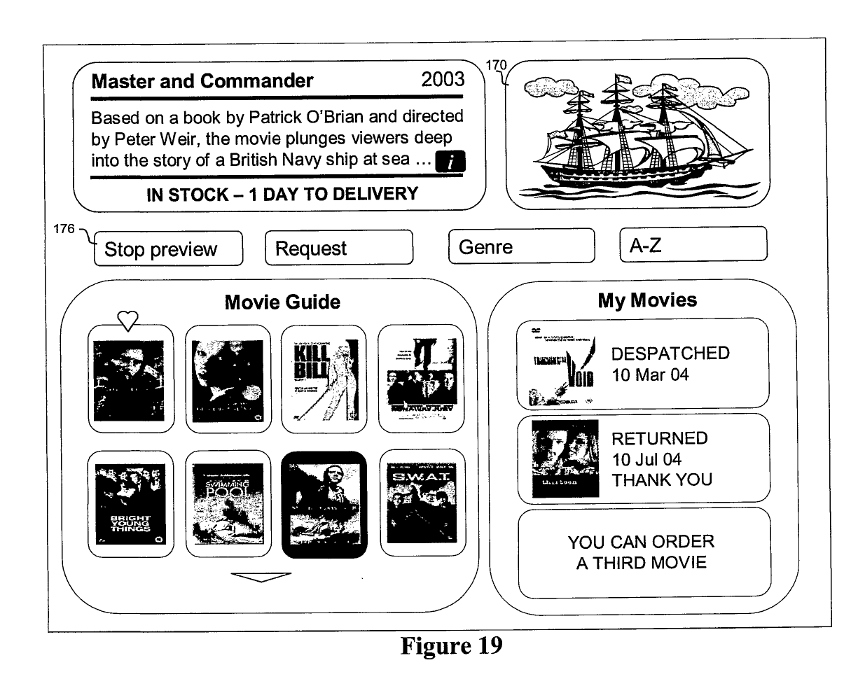

A number of audio-video clips may be downloaded and stored on the television platform. Each clip corresponds to a title that may be displayed within either the Movie Guide area 160 or the My Movies area 165. Referring to FIG. 14, a labelled (e.g. “Preview”) area 176 is displayed to indicate to the user that a clip playback facility is available if a clip is stored on the television platform whose title corresponds to that associated with the cell currently in focus 164. This is useful because it saves a user the inconvenience of inadvertently selecting the playback function for a clip that is not currently stored on the platform. If a clip is available for preview, the user may press the hot key 124 that is associated with the preview cell 176 to cause the clip to be played in the picture in graphic area 170 in place of the current television programme as shown in FIG. 19 or in full screen.

During playout of the clip a labelled area 176 displays the option to terminate playback of the clip (e.g. “Stop preview”) by pressing again preferably the same hotkey 124. During playback of a clip, user may press the arrow keys 124 to change focus to another title cell 161 or 166, whereupon program notes 169 and clip playback in area 170 or video 220 are immediately replaced with playback of the title associated with the new cell in focus from its beginning. Where a clip corresponding to the new cell is not stored on the platform then preferably a blank area, or a diagnostic message (e.g. “Clip not available”), is displayed in area 170. The process of instantly replacing playback of one title with another title according to the cell currently in focus is useful because it allows a user to enjoy a stream of uninterrupted preview clips without frequently having to select another title for play. If the clip's playback is not prematurely terminated by the user, then the IPG plays it to its end and then plays the audio corresponding to the current programme and its video in area 170 or in full screen 220.

Searching for a Title by Keyword

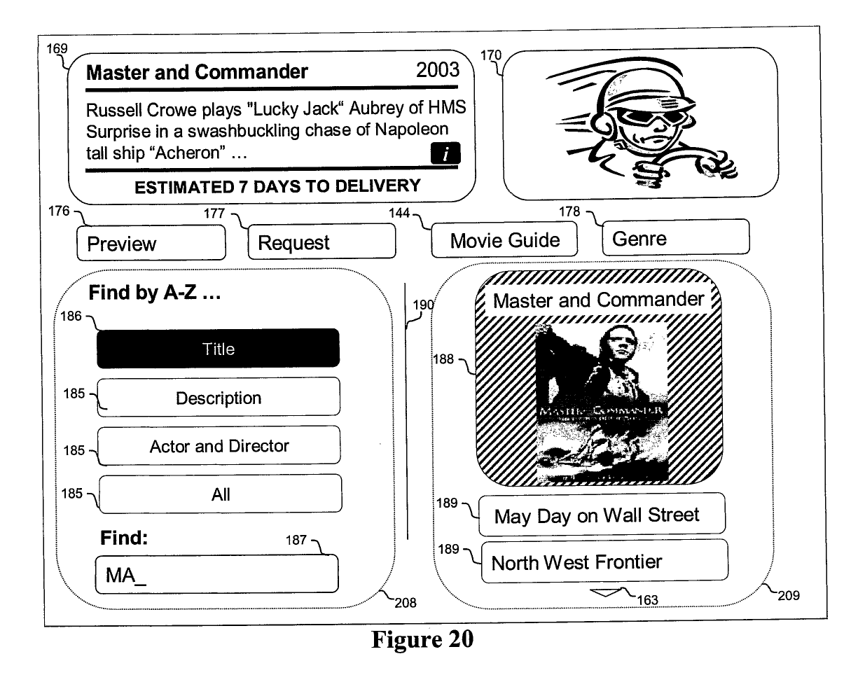

Several hundred or thousand titles may potentially be stored within the catalogue on the platform, so that it is not necessarily feasible for a user to locate a title solely using the scrollable Movie Guide area 160. The preferred embodiment employs a search process whereby a user may compose a portion of a title's name or some other catalogue attribute that may be linked to it via its Titles table record, such as its description or part of an actor's or director's name. To enter and operate in a search by title mode from the Movie Guide and My Display mode of FIG. 13, the user presses the remote button 124 that is associated with the title search label cell 179 within the Movie Guide and My Guide display mode illustrated in FIG. 14. This causes the IPG screen to be redrawn, as shown in FIG. 20, to display a keyword composition box 187, a plurality of attribute labels 185 and 186 of which the label corresponding to the title name attribute 186 is highlighted differently to the other labels 185 to show that it is in focus by default, and a separator 190 is displayed to indicate that said cells belong to a distinct, first bounded portion 208 of the display. Moreover, these cells are depicted to show that a first portion of cells is selected, such as by rendering the selected cells in colour. The user may press the cursor keys 120 to move focus to another label 185 corresponding to his or her desired search attribute. Once the attribute is selected, the user composes a keyword within the box 187 using the numeric keys 123 in a multiple key press mode of operation according to their alphabetic labels as widely employed for composition of SMS text messages on mobile telephones. Pressing, for example, the “3” key twice causes the letter “E” to be added to the SMS text string in box 187 after a short delay. Cells 188 and 189 are depicted differently to cells 185 and 186 in the first portion of the display, such as by rendering in shades of grey, to show that the portion is not selected by the user. Immediately after each key press the IPG performs a search against TitleName within its catalogue database, TitleCatalogue, for matches against the text string as currently composed after each key press and displays a list of title cells 188 and 189 for which a match exists with the keyword in a second, right half portion of the screen. The list is sorted in alphabetic order by title and the first cell in the list 188 is highlighted differently to the other cells 189 such as, for example, by the patterned background effect of 188 in FIG. 20.

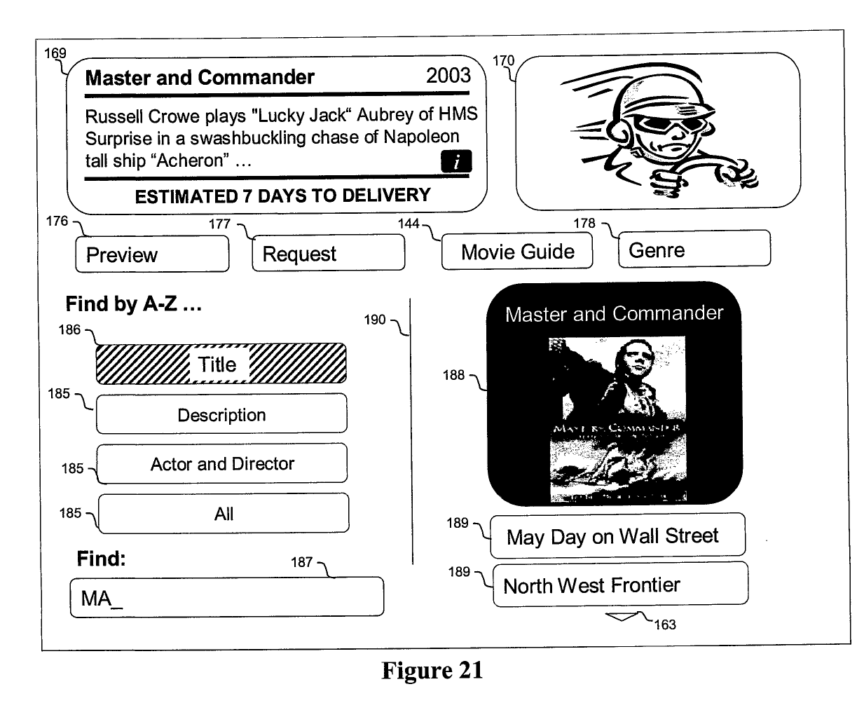

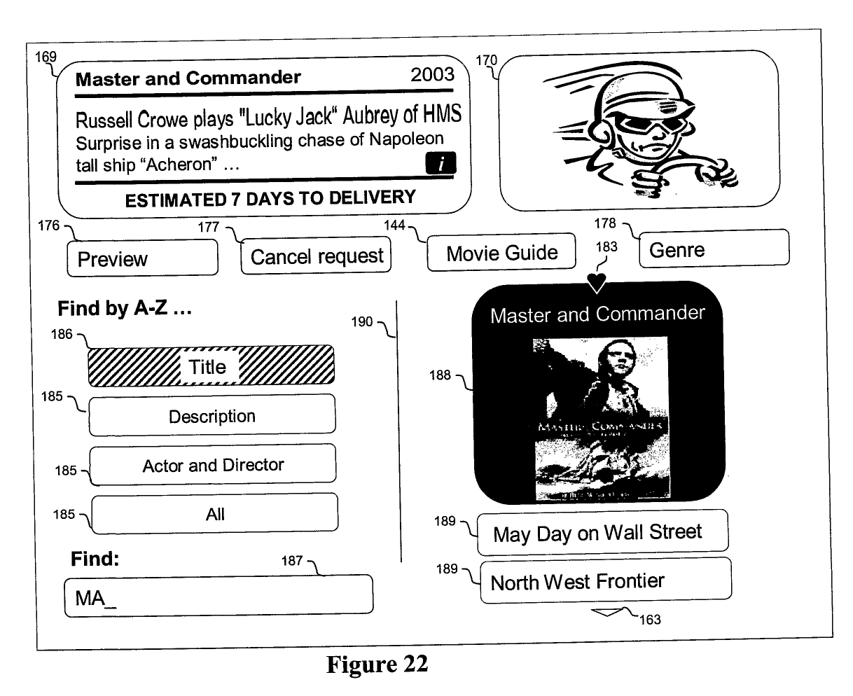

In order to study the results of the search, the user may press an arrow key 120 during the composition of the keyword text in box 187 to cause focus to move from an attribute label 186 in the first portion to the highlighted title cell 188, whereupon the cells of the first portion 208 and the second portion 209 exchange their highlighted appearances and depictions so that, following the example above, cell 186 takes on a patterned effect to show that it is highlighted but not in focus and cell 188 takes on a black background to show that it is in focus as shown in FIG. 21. Further, the first portion 208 of cells is depicted in colour to show that they are selected. Where a results cell 188 or 189 corresponds to a title that is currently requested, it is depicted differently compared to cells that are not requested, such as by annotating the marker 183 in FIG. 22. The user may press arrow keys 120 to move focus between the cells 188 and 189. A scroll marker 163 may further be displayed above or below cells 188 and 189 to indicate to the user whether additional cells 189 are hidden and may be brought into view by pressing an arrow key 120 of equivalent direction.

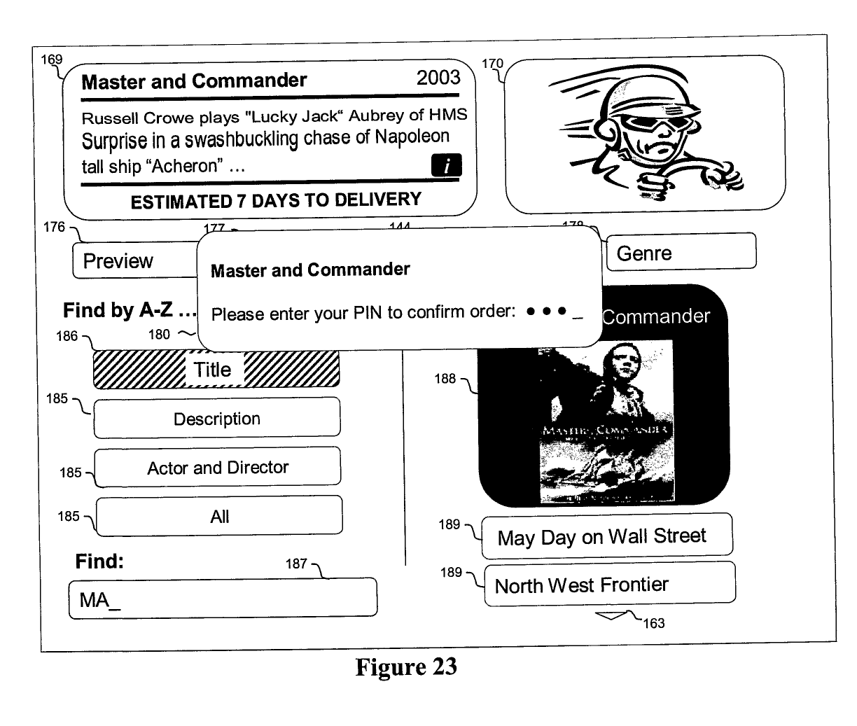

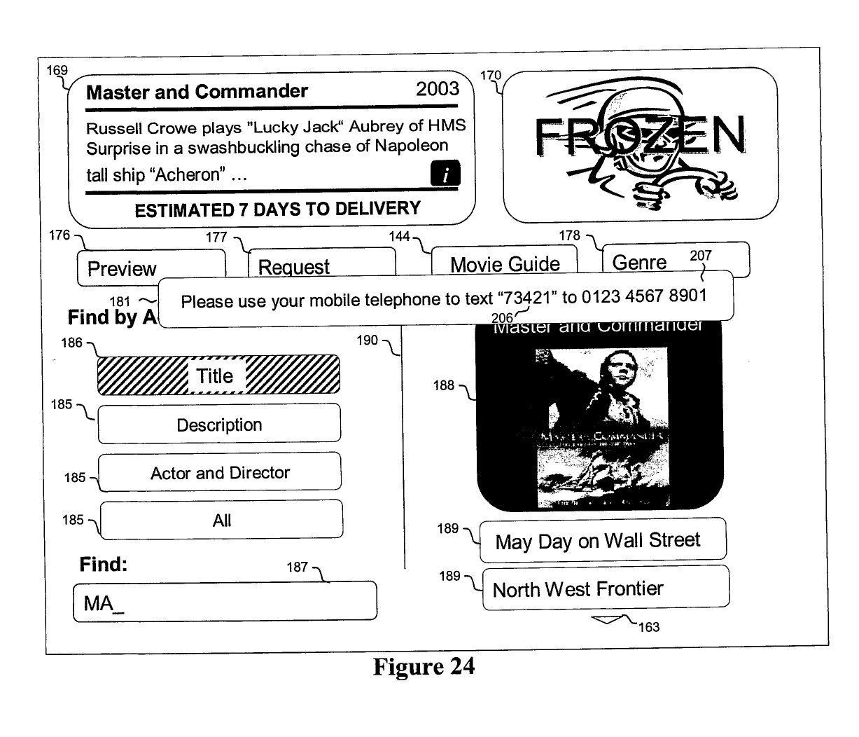

Simultaneous to the IPG displaying a cell 188 in focus, it also updates the notes box 169 to display descriptive information that is relevant to said cell's title. A preview label 176 is displayed where a clip is stored on the platform 109 that corresponds to the title of the highlighted cell 188 irrespective of whether it is in focus. By pressing a key 124 on the remote handset 117 that corresponds to label 176 a user may cause the IPG to play the clip in either the picture in graphic area 170 or alternatively to full screen according to the method previously described. By the pressing a key on the remote handset 117 that corresponds to the request label 177 a PIN request box 180 is displayed as shown in FIG. 23, followed by an instruction box 181 as shown in FIG. 24. The overall request process is otherwise the same as described in the TitleRequest process and the IPG returns to the Movie Guide display mode, as shown in FIG. 14, immediately after the IPG has downloaded and decoded the operator's packet addressed to the television platform.

There are several aspects to the aforesaid search by keyword process that are useful. For example, users are most likely to use the title name search attribute and, consequently, are not required to select an attribute by pressing further keys. Additionally, the user does not have to compose the whole of a keyword before results are evident in the second portion of the screen.

Searching for a Title by Genre

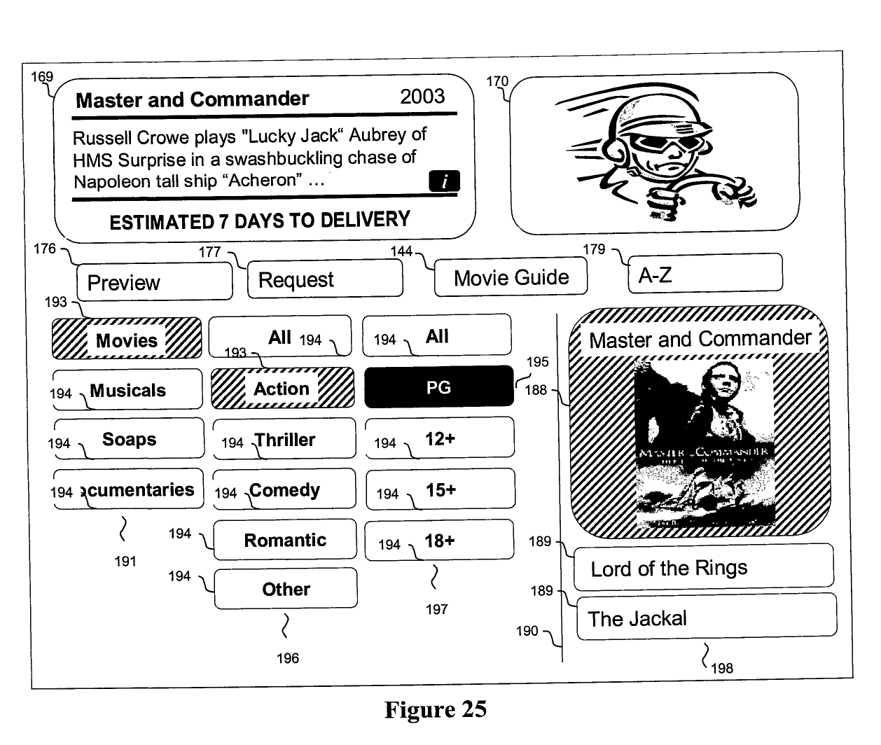

Given that TitleCatalogue may comprise many titles, the preferred embodiment employs a search process whereby a user may successively apply or step through a plurality of filter criteria in order to reduce the result list to manageable proportions in terms of the number of possible title cells a user may wish to view. The user causes the IPG to enter and operate in a search by genre mode from within the Movie Guide and My Guide display mode as illustrated in FIG. 14 by pressing the remote button that is associated with the genre search label cell 178 (i.e. “Genre”). This causes the IPG screen to be redrawn to display a plurality of columns of cells 191, 196 and 197, as shown in FIG. 25. Each column corresponds to a filter attribute, for example, a first level genre category (corresponding to ParentGenre in the Genres table of FIG. 8), a second level genre category, Titles->Genre, and a parental rating attribute, Titles>Rating, as shown for columns for 191, 196 and 197 respectively. Further, each column contains cells that correspond to the different allows values of the column's attribute, and contains one cell, 193 or 195, that is in focus or is highlighted differently compared to other cells in the same column, where said focus or highlight denotes the value of the attribute to be employed during the filter process. The topmost cell in each of columns 191, 196 and 197 is labelled “All” to cause, when said cell is selected, no filtration criterion to be applied using the attribute corresponding to said column.

The IPG draws the top cell in the leftmost column 191 in focus. The user may press the up and down arrow keys 120 to move the focus to another cell in the direction of the arrow key pressed. The user may press the left or right arrow keys 120 to change the cell in focus to a cell in an equivalent direction in an adjacent column. The previously focussed cell of the previous column is highlighted 193 to indicate that the IPG is filtering using the attribute value corresponding to the highlighted cell. Simultaneous with this, the IPG displays title cells 188 and 189 in a rightmost column 198 separated by a line 190 and applies filter criteria on the titles within TitleCatalogue according to the attribute values that correspond to the highlighted cells 193 and 195 in the attribute columns 191, 196 and 197. Further, the IPG displays the title cells in column 198 that satisfy all the filter criteria in alphabetical order, with the first cell title 188 highlighted differently compared to the other title cells 189.

Using the arrow keys 120 the user nay move focus to the rightmost results title cell column 198 and move focus to another cell in said column. Simultaneously, the IPG updates the notes box 169 to display descriptive information that are relevant to the highlighted result cell 188 title. By the pressing a key on the remote handset 117 that corresponds to label 176 a user may cause the IPG to play a clip in either the picture in graphic area 170 or alternatively to full screen according to the same method as described earlier. By the pressing a key on the remote handset 117 that corresponds to the request label 177 a PIN request box 180 appears as previously described in FIG. 23 for Searching for a title by keyword, followed by an instruction box 181 as shown in FIG. 24. The overall request process is otherwise the same as described in the TitleRequest process and the IPG returns to the Movie Guide display mode as shown in FIG. 23 immediately after the IPG has downloaded and decoded the operator's packet addressed to the television platform.

Using the genre search genre process, users can easily adjust a filter parameter through use of the arrow keys and, at a glance, continue to see the values of all the filter parameters, the filtered results and an in-depth description of a title of interest on one screen.

Adaptation of Telecast IPG to Display DVD Titles

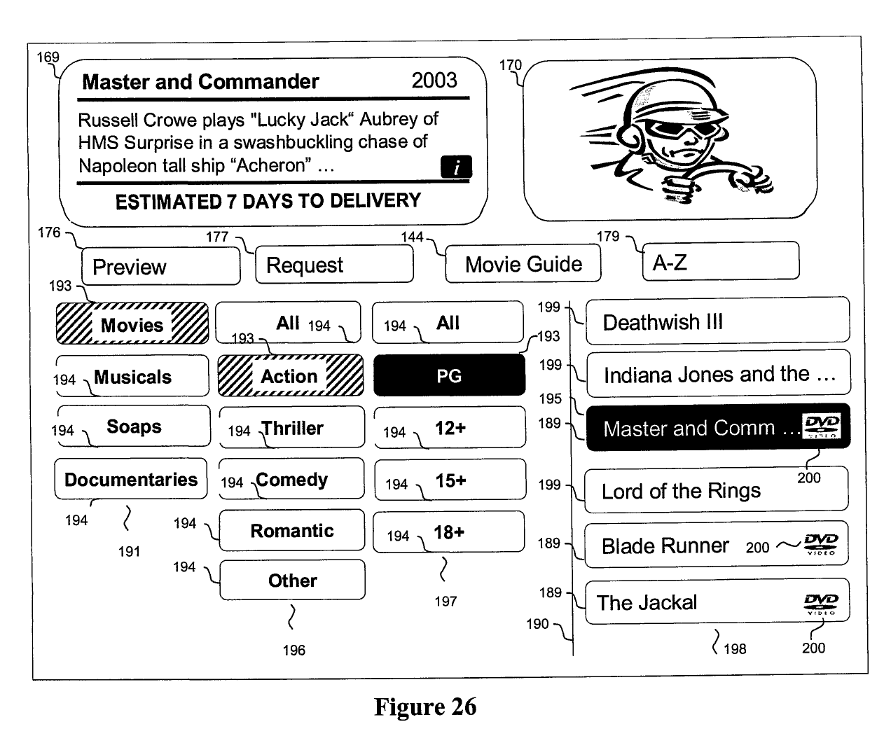

A useful feature to viewers of telecast IPGs would be to highlight the availability also of DVD titles in addition to telecast programmes. This is especially useful on digital terrestrial television (DTT) and analogue television networks where there are often insufficient channels available for movie channels. Using the feature described below, a viewer can convenient locate movies of interest when there is nothing of interest elsewhere. The telecast IPG is adapted to display results from a DVD title search combined with display of results from a title search of telecast programmes, as shown in FIG. 26.

Users may activate a search for both telecast programmes and DVD titles simultaneously from a telecast IPG, such as shown in FIG. 12, by pressing a remote key 124 corresponding to a search action label 145 displayed within said IPG to initiate a search action against both telecast and DVD titles simultaneously. The search results for telecast and DVD titles are displayed together on screen simultaneously, as shown by cells 189 and 199 of, where DVD title results cells 189 are depicted differently from telecast result cells 199 by annotating each of the DVD title cells 189 with a marker or icon 200. Moreover, action labels corresponding to user selection of the preview and request actions, 176 and 177 respectively, are displayed only if the result cell in focus 195 corresponds to a DVD title.

A skilled person will appreciate that variations of the disclosed arrangements are possible. For example, analogue broadcast network and receiving methods could be employed. In addition, although the application focuses on DVDs, the system and methods described are readily applicable to ordering of a title stored on other tangible media, such as VHS (Video Home System) cassette tapes and music CDs (Compact Disc). Also, the system and methods described are readily applicable to purchase, instead of loan, of a title. Accordingly the above description of the specific embodiment is made by way of example only and not for the purposes of limitation. It will be clear to the skilled person that minor modifications may be made without significant changes to the operation described.

1. An interactive program guide that is operable to display on a screen or monitor at least one identifier associated with an audio/visual media; receive an interactive user selection of one of the identified audio/visual media; and display an order instruction for ordering the selected audio/visual media for non-electronic delivery, the order instruction preferably including a code/identifier indicative of the user selection.

2. An interactive program guide as claimed in claim 1 that is operable to receive audio/visual media information via a television signal broadcast prior to a user selection and use that information to display the media identifiers.

3. An interactive program guide as claimed in claim 1 that is operable to display a currently viewed television program simultaneously with the audio/visual media identifiers.

4. An interactive program guide as claimed in claim 1 that is operable to display a clip of a selected audio/video media simultaneously with the audio/visual media identifiers.

5. An interactive program guide as claimed in claim 1 wherein the instructions for ordering the selected audio/visual media comprise a telephone number.

6. An interactive program guide as claimed in claim 1 operable to display customised user order information, preferably simultaneously with the at least one identifier that is displayed for user selection.

7. An interactive program guide as claimed in claim 6 wherein the user order information includes information indicative of despatched audio/visual media; returned audio/visual media and audio/visual media available for order.

8. An interactive program guide as claimed in claim 1 operable to display a search screen to allow a user to search for available audio/visual media and/or telecast programmes according to one or more criteria, and display the search results.

9. An interactive program guide as claimed in claim 8 wherein the one or more criteria include any one or more of title; description; actor; director; genre.

10. An interactive program guide as claimed in claim 8 wherein identifiers for the audio/visual media found in the search are displayed in a portion of the screen/monitor adjacent the search screen.

11. An interactive program guide as claimed in claim 1 operable to display television schedule information.

12. An interactive program guide as claimed in claim 1 wherein the identifier associated with the audio/visual media comprises at least one of a title; a thumbnail.

13. An interactive program guide as claimed in claim 1 operable to indicate audio/visual media availability based on information downloaded from a service provider.

14. An interactive program guide as claimed in claim 1 operable to prompt a user to enter a personal identification number prior to display of the order instruction.

15. An interactive program guide as claimed in claim 1 operable to highlight or mark an identifier to indicate that it belongs to a queue of requested titles in the event that it is not available for order immediately.

16. An interactive television system comprising means for displaying on a screen or monitor at least one identifier associated with an audio/visual media that is available for delivery via a non-electronic channel; means for receiving an interactive user selection of one of the identified audio/visual media; means for displaying on the screen or monitor an order instruction for the user including instructions for ordering the selected audio/visual media, and means for receiving an order from the user via a telephone or internet network.

17. An interactive television system as claimed in claim 16 comprising means for receiving audio/visual media information via a television signal broadcast and using that information to display the media identifiers.

18. An interactive television system as claimed in claim 16 comprising means for requesting audio/visual media availability information in response to a user selection.

19. An interactive television system as claimed in claim 16 comprising means for displaying a currently viewed television program simultaneously with the audio/visual media identifiers.

20. An interactive television system as claimed in claim 16 comprising means for displaying a clip of a selected audio/video media simultaneously with the audio/visual media identifiers.

21. An interactive television system as claimed in claim 16 wherein the instructions for ordering the selected audio/visual media comprise a telephone number.

22. An interactive television system as claimed in claim 16 comprising means for displaying customised user order information.

23. An interactive television system as claimed in claim 22 wherein the user order information includes information indicative of despatched audio/visual media; returned audio/visual media and audio/visual media available for order.

24. An interactive television system as claimed in claim 16 comprising means for displaying a search screen to allow a user to search for available audio/visual media according to one or more criteria.

25. An interactive program guide as claimed in claim 24 wherein the one or more criteria include any one or more of title; description; actor; director; genre.

26. An interactive television system as claimed in claim 24 wherein identifiers for the audio/visual media found in the search are displayed in a portion of the screen/monitor adjacent the search screen.

27. An interactive television system as claimed in claim 16 comprising means for displaying television schedule information, simultaneously with a user selectable means to enter a screen including the identifier associated with an audio/visual media.

28. An interactive television system as claimed in claim 16 wherein the identifier associated with the audio/visual media comprises at least one of a title; a thumbnail.

29. An interactive television system as claimed in claim 16 comprising means for indicating audio/visual media availability based on information downloaded or broadcasted from a service provider.

30. An interactive television system as claimed in claim 16 comprising means for highlighting or marking an identifier to indicate that it belongs to a queue of requested titles in the event that it is not available for order immediately.

31. An interactive television system as claimed in claim 16 wherein the means for receiving the user order comprise at least one of means for interpreting numbers entered via a telephone key pad; means for interpreting an SMS text message; speech recognition means for interpreting commands spoken via a telephone connection; a call centre.
